(19) United States
(12) Patent Application Publication
(10) Pub. No.: US 2024/0242386 A1
(43) Pub. Date: Jul. 18, 2024

(54) IMAGE PROCESSING DEVICE AND IMAGE BLURRING METHOD

(71) Applicant: SK hynix Inc., Icheon-si Gyeonggi-do (KR)

(72) Inventors: Tae Hyun KIM, Icheon-si Gyeonggi-do (KR); Jin Su KIM, Icheon-si Gyeonggi-do (KR); Jong Hyun BAE, Icheon-si Gyeonggi-do (KR)

(73) Assignee: SK hynix Inc., Icheon-si Gyeonggi-do (KR)

(21) Appl. No.: 18/349,728

(22) Filed: Jul. 10, 2023

(30) Foreign Application Priority Data
Jan. 16, 2023 (KR) 10-2023-0006098

(51) Int. Cl. G06T 7/00; G06T 5/00; G06T 5/50

(52) U.S. Cl. CPC G06T 7/97; G06T 5/002; G06T 5/003; G06T 5/50; G06T 2207/20221

(57) ABSTRACT

An image processing device for performing an image blurring method includes an image preprocessor configured to determine an in-focus area and an out-of-focus area for sub-images of an externally received image, the sub-images generated based on pixel values of the externally received image. The image processor is also configured to calculate disparity values between the sub-images in the out-of-focus area. The image processing device further includes an image combiner configured to perform a blur operation on the out-of-focus area depending on a strength of the blur operation determined based on the disparity values and to sum sub-images on which the blur operation is performed.

### CROSS-REFERENCE TO RELATED APPLICATION

The present application claims priority under 35 U.S.C. § 119(a) to Korean patent application number 10-2023-0006098 filed on Jan. 16, 2023, in the Korean Intellectual Property Office, the entire disclosure of which is incorporated by reference herein.

### BACKGROUND

### 1. Technical Field

Various embodiments of the present disclosure generally relate to an image processing device, and more particularly, to an image processing device and an image blurring method.

### 2. Related Art

Generally, an image sensor may be classified as a charge coupled device (CCD) image sensor or a complementary metal oxide semiconductor (CMOS) image sensor. Recently, the CMOS image sensor, which has low manufacturing cost, has low power consumption, and facilitates integration with a peripheral circuit, has attracted attention.

An image sensor included in a smartphone, a tablet PC, or a digital camera may acquire image information of an external object by converting light reflected from the external object into an electrical signal. An image signal processing device may perform operations of converting the electrical signal acquired from the image sensor or improving image quality.

The image signal processing device may perform a blur operation of blurring the background of an image. Through the blur operation, a main object included in an image may be highlighted. The blur operation may be performed by calculating electrical signals acquired through two or more mobile cameras. However, as the blur operation is performed, the complexity of an image processing operation may be increased, and the quality of images may be deteriorated.

### SUMMARY

Various embodiments of the present disclosure are directed to an image processing device and an image processing method, which perform a blur operation on a background based on depth information included in pixel values and control the strength of the blur operation performed on the background.

An embodiment of the present disclosure may provide for an image processing device. The image processing device may include an image preprocessor configured to determine an in-focus area and an out-of-focus area for sub-images of an externally received image, the sub-images generated based on pixel values of the externally received image and to calculate disparity values between the sub-images in the out-of-focus area, and an image combiner configured to control the strength of a blur operation performed on the out-of-focus area based on the disparity values and sum sub-images on which the blur operation is performed.

An embodiment of the present disclosure may provide for an image processing method. The image processing method may include generating sub-images of an externally received image, based on pixel values of the externally received image, determining an in-focus area and an out-of-focus area for the sub-images of the image, calculating disparity values between the sub-images in the out-of-focus area, and controlling a strength of a blur operation that is performed on the out-of-focus area based on the disparity values and summing sub-images on which the blur operation is performed.

An embodiment of the present disclosure may provide for an image processing system. The image processing system may include an image sensor including a plurality of micro-lenses and configured to generate pixel values including information about phases in all pixels, the plurality of sub-pixels, an image preprocessor configured to generate a number of sub-images of the image identical to the number of pixels corresponding to each of the plurality of micro-lenses based on pixel values received from the image sensor, determine an out-of-focus area for the sub-images based on pixel values of the sub-images and a preset threshold value, and calculate disparity values between pixels included in the out-of-focus area, and an image combiner configured to control a strength of a blur operation performed on positions of the pixels included in the out-of-focus area based on the disparity values and generate a blurred image on which the blur operation is performed only on the out-of-focus area.

### BRIEF DESCRIPTION OF THE DRAWINGS

FIG. 1 is a diagram illustrating an image processing device according to an embodiment of the present disclosure.

FIG. 2 is a diagram illustrating micro-lenses included in an image sensor according to an embodiment of the present disclosure.

FIG. 3 is a diagram illustrating an in-focus area according to an embodiment of the present disclosure.

FIG. 4 is a diagram illustrating an out-of-focus area according to an embodiment of the present disclosure.

FIG. 5 is a block diagram illustrating an image processing operation according to an embodiment of the present disclosure.

FIG. 6 is a diagram illustrating a method of generating sub-images according to an embodiment of the present disclosure.

FIG. 7 is a diagram illustrating a method of detecting an out-of-focus area according to an embodiment of the present disclosure.

FIG. 8 is a diagram illustrating a method of calculating disparity values according to an embodiment of the present disclosure.

FIG. 9 is a diagram illustrating a method of calculating disparity values using the difference between sub-pixel values according to an embodiment of the present disclosure.

FIG. 10 is a diagram illustrating a method of calculating disparity values using the difference between the rankings of sub-pixel values according to an embodiment of the present disclosure.

FIG. 11 is a diagram illustrating a method of controlling the strength of a blur operation by scaling disparity values according to an embodiment of the present disclosure.

FIG. 12 is a diagram illustrating a method of controlling the strength of a blur operation by changing the sharpness of a Gaussian filter according to an embodiment of the present disclosure.

FIG. 13 illustrates a table in which disparity values are mapped to sharpness values of a Gaussian filter according to an embodiment of the present disclosure.

FIG. 14 is a flowchart illustrating a method of performing a blur operation on a background according to an embodiment of the present disclosure.

FIG. 15 is a flowchart illustrating a method of generating a blurred image according to an embodiment of the present disclosure.

FIG. 16 is a flowchart illustrating a method of generating a blurred image according to an embodiment of the present disclosure.

FIG. 17 is a block diagram illustrating an electronic device including an image processing device according to an embodiment of the present disclosure.

### DETAILED DESCRIPTION

Specific structural or functional descriptions of embodiments of the present disclosure introduced in this specification or application are provided as examples to describe embodiments according to the concept of the present disclosure. The embodiments according to the concept of the present disclosure may be practiced in various forms, and should not be construed as being limited to the embodiments described in the specification or application.

Various embodiments of the present disclosure will now be described in detail with reference to the accompanying drawings so that those skilled in the art can practice the technical spirit of the present disclosure.

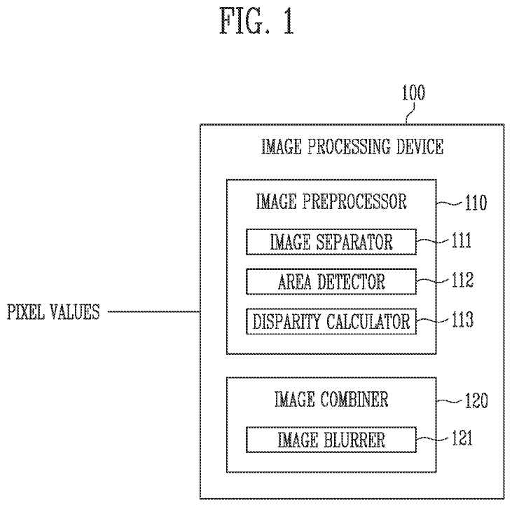

FIG. 1 is a diagram illustrating an image processing device according to an embodiment of the present disclosure.

Referring to FIG. 1, an image processing device 100 may include an image preprocessor 110 and an image combiner 120. The image processing device 100 may receive a plurality of pixel values from an image sensor including a plurality of pixels.

The image preprocessor 110 may determine an in-focus area and an out-of-focus area for sub-images of an externally received image, generated based on pixel values of the externally received image. The image preprocessor 110 may calculate disparity values between sub-images in the out-of-focus area. The image preprocessor 110 may include an image separator 111, an area detector 112, and a disparity calculator 113.

The image separator 111 may sample sub-pixel values respectively corresponding to a plurality of micro-lenses included in the image sensor. The image separator 111 may generate a plurality of sub-images based on the sampled sub-pixel values. In an embodiment of the present disclosure, the number of sub-images generated by the image separator 111 may be identical to the number of sub-pixel values corresponding to the same micro-lens.

The area detector 112 may compare the difference between the maximum value and the minimum value of sub-pixels at the same position (i.e., co-located or collocated sub-pixels) in sub-images with a preset threshold value. The area detector 112 may determine the positions of the sub-pixels to be in the in-focus area or out-of-focus area based on the result of the comparison.

The disparity calculator 113 may calculate disparity values between sub-images using the difference between sub-pixel values corresponding to the out-of-focus area or the difference between the rankings of sub-pixel values. In an embodiment of the present disclosure, the disparity calculator 113 may detect features included in the sub-images, and may calculate disparity values between the sub-images using the detected features.

The image combiner 120 may control the strength of a blur operation that is performed on the out-of-focus area based on the disparity values. The image combiner 120 may generate a blurred image in which the sub-images on which the blur operation is performed are summed. The image combiner 120 may include an image blurrer 121.

The image blurrer 121 may increase the disparity values depending on a preset rate. When the disparity values between the sub-images are increased, the strength of the blur operation that is performed on the out-of-focus area may be increased. In an embodiment of the present disclosure, the image blurrer 121 may apply a blur filter to the out-of-focus area. The strength of the blur filter to be applied may vary depending on the disparity values.

Although not illustrated in FIG. 1, the image sensor including the plurality of pixels may generate image data about an object that is input through a lens. The image data may include a plurality of pixel values. The image sensor may include a lens for forming an optical system and micro-lenses corresponding to pixels. In an embodiment of the present disclosure, the image sensor may transfer the plurality of pixel values of the generated image data to the image processing device 100.

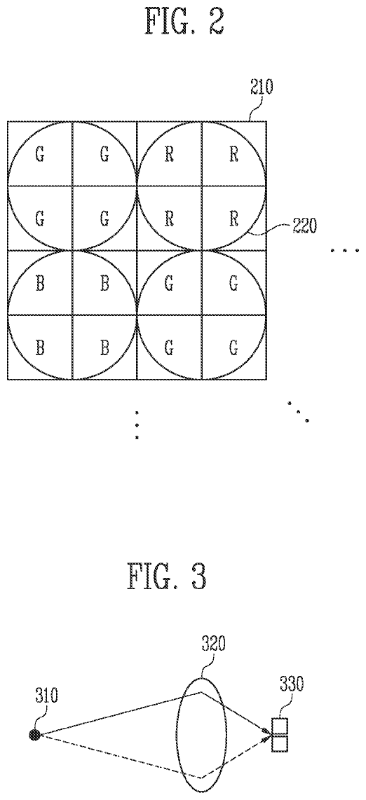

FIG. 2 is a diagram illustrating micro-lenses included in an image sensor according to an embodiment of the present disclosure.

Referring to FIG. 2, a plurality of pixels may correspond to one micro-lens. FIG. 2 illustrates the case where four pixels correspond to one micro-lens by way of example. In the present specification, the pixels which share the micro-lens with each other or correspond to the micro-lens may be referred to as sub-pixels.

In FIG. 2, the sub-pixels may be pixels, each including a color filter. In the specification of the present disclosure, a green pixel may refer to a pixel including a green filter, and this may be equally applied to other color pixels. Four adjacent green pixels may correspond to one micro-lens. Similarly, four red pixels or four blue pixels may correspond to one micro-lens. Each micro-lens may be shared by sub-pixels, and the colors of color filters included in the sub-pixels sharing the same micro-lens may be identical to each other.

In FIG. 2, 16 sub-pixels may correspond to four micro-lenses. The sub-pixels may be disposed below the micro-lenses. The colors of the plurality of sub-pixels corresponding to the same micro-lens may be identical to each other.

For example, the red pixels 210 may correspond to a micro-lens 220. The red pixels 210 may be separated into a first sub-pixel, a second sub-pixel, a third sub-pixel or a fourth sub-pixel depending on the positions of the sub-pixels. Light may be incident on the red pixels 210 through the micro-lens 220. Depending on the positions of sub-pixels, pixel values generated by the red pixels 210 may vary. Because phase information of the pixels may be calculated based on the difference between the pixel values, the pixel values of the red pixels 210 may include phase information. Similarly, the pixel values of four blue pixels or four green pixels may also include phase information. In an embodiment of the present disclosure, the depth information of an image may be calculated based on the phase information of the pixels.

Embodiments of the present disclosure are not limited to the case where four sub-pixels correspond to one micro-lens. The number of sub-pixels corresponding to one micro-lens may be variously set. Even in this case, the colors of sub-pixels corresponding to the same micro-lens may be identical to each other, and all the pixel values of the sub-pixels may include phase information.

In an embodiment of the present disclosure, the image sensor may generate pixel values including information about phases in all pixels.

FIG. 3 is a diagram illustrating an in-focus area according to an embodiment of the present disclosure.

Referring to FIG. 3, light reflected from an object 310 may reach sub-pixels 330 through a micro-lens 320. The state in which light passing through the micro-lens 320 is focused on one point of the sub-pixels 330 may be referred to as an “in-focus” state. When a plurality of sub-pixels correspond to one micro-lens, an in-focus area may refer to an area in which light passing through the micro-lens 320 converges on the first surfaces of pixels having the same color.

As shown in FIG. 3, in the in-focus area, light passing through the micro-lens 320 converges on one point, and thus almost no difference may be present between pixel values of the sub-pixels 330 that share one micro-lens. The case where the difference between the pixel values of the sub-pixels 330 is less than a preset threshold value may be regarded as the in-focus area.

A blur operation might not be performed on the area which is determined to be an in-focus area in the image based on the pixel values. In an embodiment of the present disclosure, an image may be output without performing a blur operation on the in-focus area, whereby the overall computational load may be reduced compared to the case where a blur operation is performed on the entire image. In an embodiment of the present disclosure, a depth corresponding to the in-focus area may be set as a reference based on the pixel values, and thus the depth information of the image may be acquired.

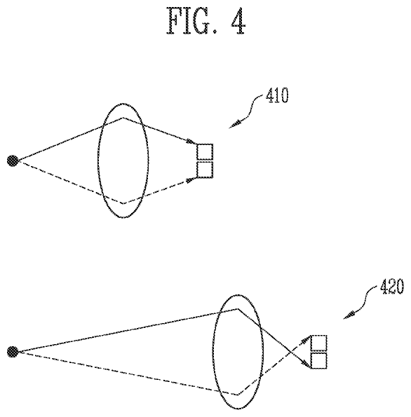

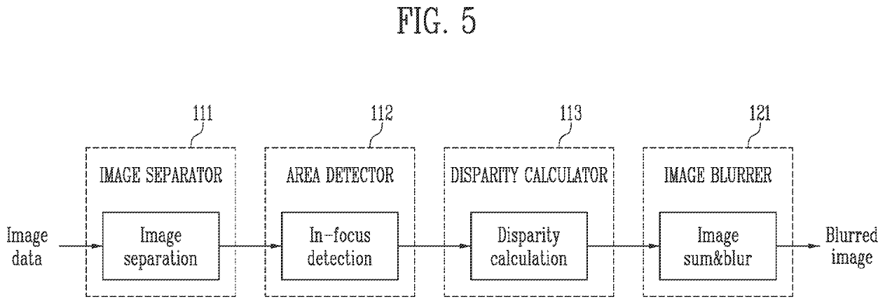

FIG. 4 is a diagram illustrating an out-of-focus area according to an embodiment of the present disclosure.

Referring to FIG. 4, incident light might not converge on sub-pixels through a micro-lens. The case where light passing through the micro-lens does not converge on one point may be regarded as an out-of-focus state. When a plurality of sub-pixels correspond to one micro-lens, an out-of-focus area may refer to an area in which light passing through the micro-lens converges on a point other than pixels having the same color.

In FIG. 4, the case 410 where light passing through the micro-lens passes through sub-pixels to converge on the far side and the case 420 where a point on which light passing through the micro-lens converges is located between the micro-lens and the sub-pixels are illustrated by way of example. Even though the pixel values of sub-pixels included in an out-of-focus area in the image have the same color and the sub-pixels are adjacent to each other, the differences between the pixel values may be greater than the preset threshold value. The depth information of the object may be calculated using the pixel values of sub-pixels included in the out-of-focus area.

The out-of-focus area may be determined to be a background in the image, and thus a blur operation may be performed thereon. In an embodiment of the present disclosure, the depth information of the out-of-focus area may be determined to be relative to that of the in-focus area.

FIG. 5 is a block diagram illustrating an image processing operation according to an embodiment of the present disclosure.

Referring to FIG. 5, the image processing device 100 may generate a blurred image using received image data. The image data may be pixel values.

The image separator 111 may generate sub-images by separating an image based on the image data. The image separator 111 may sample sub-pixel values respectively corresponding to a plurality of micro-lenses. The image separator 111 may perform an image separation operation of separating an image into sub-images including sub-pixel values. The sub-pixel values included in the same sub-image may be sampled at the same sampling position in the micro-lenses.

The area detector 112 may determine whether the sub-pixels are included in an in-focus area or an out-of-focus area by performing an area detection operation. The area detector 112 may compare the difference between the maximum value and the minimum value of sub-pixels at the same position (i.e., co-located sub-pixels) in sub-images with a preset threshold value. The area detector 112 may include the position of sub-pixels, for which the difference between the maximum value and the minimum value is less than the threshold value, in the in-focus area. The area detector 112 may include the position of sub-pixels, for which the difference between the maximum value and the minimum value is equal to or greater than the threshold value, in the out-of-focus area.

The disparity calculator 113 may perform a disparity calculation operation of calculating disparity values between sub-images. In an embodiment of the present disclosure, the disparity values may be calculated using the difference between sub-pixel values corresponding to the out-of-focus area or the difference between the rankings of the sub-pixel values.

In an embodiment of the present disclosure, the disparity values may be calculated based on features detected from the sub-images. For example, the disparity calculator 113 may calculate disparity values using a Dense-scale invariant feature transform (Dense-SIFT) method based on the density of features.

In an embodiment of the present disclosure, the image separation operation, the image detection operation, and the disparity calculation operation may be included in an image preprocessing operation. The image preprocessor 110 may perform the image preprocessing operation before a blur operation is performed on an image background.

The image combiner 120 may generate a blurred image on which the blur operation is performed only on the background of the image. The image combiner 120 may generate a blurred image by combining (summing) sub-images for which disparity values are changed. The image combiner 120 may generate the blurred image by applying a blur filter to an intermediate image in which the sub-images are summed.

The image blurrer 121 may perform a blur operation only on the out-of-focus area. The image blurrer 121 may control the strength of the blur operation to be performed.

The image blurrer 121 may increase the disparity values depending on a preset rate. In an embodiment of the present disclosure, the strength of the blur operation may be controlled depending on the disparity values that are changed.

The image blurrer 121 may set a reference image among the sub-images. The image blurrer 121 may move the sub-pixel values of the remaining sub-images other than the reference image in a direction corresponding to the reference image. In detail, the image blurrer 121 may move the sub-pixel values of one of the sub-images in the direction horizontal to the reference image. Similarly, the image blurrer 121 may move the sub-pixel values of sub-images in the direction vertical or diagonal to the reference image.

The image blurrer 121 may determine the movement distance of sub-pixel values of the remaining sub-images based on the preset ratio and the disparity values. The disparity values between the sub-images, the sub-pixel values of which are moved, may be increased.

In an embodiment of the present disclosure, the image combiner 120 may calculate the average values of sub-pixel values of the reference image and the sub-pixel values of the remaining sub-images, which are co-located sub-pixel values in the out-of-focus area. The image combiner 120 may generate a blurred image including the average values of the sub-pixel values. In an embodiment of the present disclosure, the image combiner 120 may generate a blurred image in which the median values of the sub-pixel values of the reference image and the sub-pixel values of the remaining sub-images, which are co-located sub-pixel values, are used as the sub-pixel values of the out-of-focus area.

In an embodiment of the present disclosure, the image blurrer 121 may first generate an intermediate image including the average values of sub-pixel values of the sub-images, corresponding to the co-located sub-pixel values, in the out-of-focus area. The image blurrer 121 may apply a filter to the intermediate image based on the disparity values.

The image blurrer 121 may perform a blur operation by applying a Gaussian filter to the intermediate image. The image blurrer 121 may change the sharpness of the Gaussian filter depending on the disparity values. In an embodiment of the present disclosure, the image blurrer 121 may select the curve of the Gaussian filter having low curve sharpness as the disparity values are larger, and may then apply the selected curve to the intermediate image. In an embodiment of the present disclosure, the sharpness of the Gaussian filter may be differently applied to respective sub-pixels included in the out-of-focus area.

The image blurrer 121 may control the strength of the filter to be applied to the intermediate image depending on the preset rate. In an embodiment of the present disclosure, the corresponding Gaussian filter may be applied to the intermediate image based on a table in which disparity values, received from a user, match sharpness values of Gaussian filters.

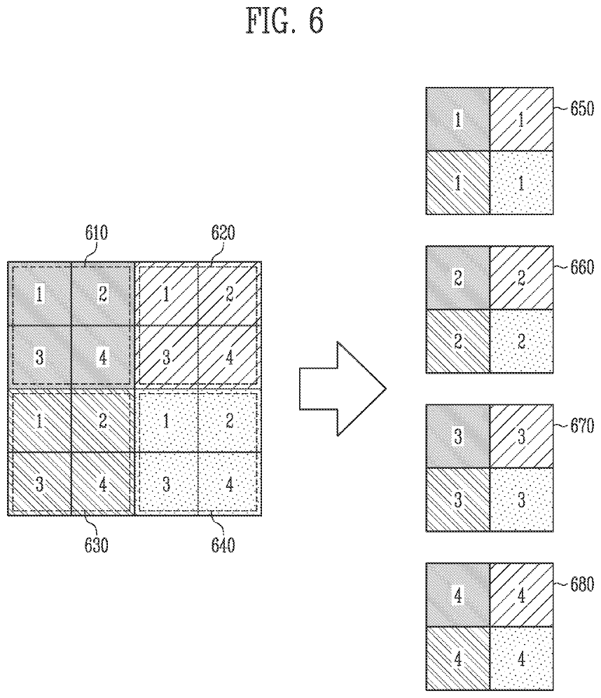

FIG. 6 is a diagram illustrating a method of generating sub-images according to an embodiment of the present disclosure.

Referring to FIG. 6, an image composed of 16 pixels may be separated into four sub-images, each including four sub-pixels. The sub-pixel values included in each sub-image may be pixel values having the same color in an original image. In detail, sub-pixels included in each sub-image may be determined depending on the positions of pixels in the original image.

As illustrated in FIG. 6, the original image may be composed of a first pixel group 610, a second pixel group 620, a third pixel group 630, and a fourth pixel group 640. The color of the first pixel group 610 and the fourth pixel group 640 may be green, the color of the second pixel group 620 may be red, and the color of the third pixel group 630 may be blue.

The first pixel group 610 may include a first sub-pixel (position #1), a second sub-pixel (position #2), a third sub-pixel (position #3), and a fourth sub-pixel (position #4) depending on the positions of the sub-pixels in the corresponding group. Similarly, each of the second pixel group 620, the third pixel group 630, and the fourth pixel group 640 may include a first sub-pixel, a second sub-pixel, a third sub-pixel, and a fourth sub-pixel.

The image separator 111 may sample one sub-pixel from each of the pixel groups 610, 620, 630, and 640. The image separator 111 may sample sub-pixels at the same position (i.e., co-located sub-pixels) in the pixel groups 610, 620, 630, and 640. For example, the first sub-pixel of the first pixel group 610, the first sub-pixel of the second pixel group 620, the first sub-pixel of the third pixel group 630, and the first sub-pixel of the fourth pixel group 640 may be sampled, and a first sub-image 650 may be generated based on the sampled sub-pixels. Similarly, a second sub-image 660, a third sub-image 670, and a fourth image 680 may be generated, and the original image may be separated into four sub-images 650, 660, 670, and 680.

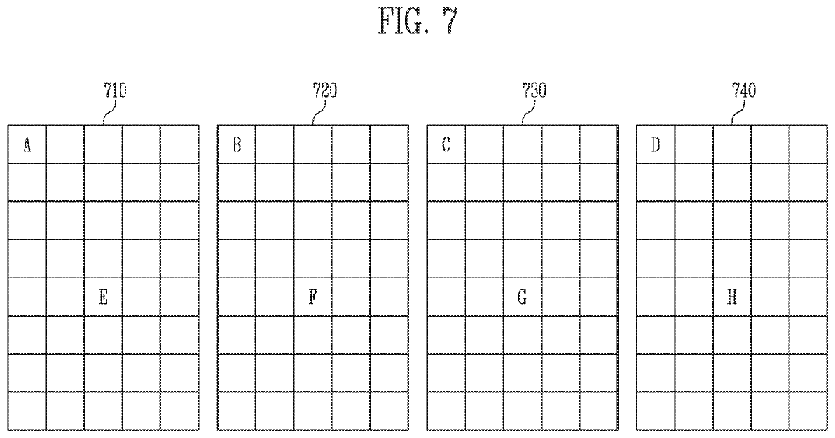

FIG. 7 is a diagram illustrating a method of detecting an out-of-focus area according to an embodiment of the present disclosure.

Referring to FIG. 7, the area detector 112 may determine whether respective positions in sub-images 710, 720, 730, and 740 correspond to an in-focus area. At respective positions in the sub-images 710, 720, 730, and 740, the area detector 112 may detect a maximum value and a minimum value among the sub-pixel values of the sub-images 710, 720, 730, and 740. When the difference between the maximum value and the minimum value is less than a preset threshold value, the area detector 112 may determine that the position of the corresponding sub-pixel is in an in-focus area. The position of a sub-pixel for which the difference between the maximum value and the minimum value is equal to or greater than the preset threshold value may be detected as being in an out-of-focus area in the corresponding sub-image.

A sub-pixel value corresponding to position (1, 1) in the first sub-image 710 may be A, a sub-pixel value corresponding to position (1, 1) in the second sub-image 720 may be B, a sub-pixel value corresponding to position (1, 1) in the third sub-image 730 may be C, and a sub-pixel value corresponding to position (1, 1) in the fourth sub-image 740 may be D. The area detector 112 may determine the position (1, 1) in the sub-images 710, 720, 730, and 740 to be in an in-focus area or an out-of-focus area based on the following equation.

if {max(A, B, C, D)−min(A, B, C, D)<threshold, in-focus}

otherwise, out-of-focus

In FIG. 7, the condition of “max(A, B, C, D)−min(A, B, C, D)<threshold” is satisfied, and then the position (1,1) in the sub-images 710, 720, 730, and 740 may be detected as being in an in-focus area. Similarly, position (5, 3) in the sub-images 710, 720, 730, and 740 may be detected as being in an out-of-focus area based on sub-pixel values E, F, G, and H corresponding to position (5,3) in the sub-images 710, 720, 730, and 740.

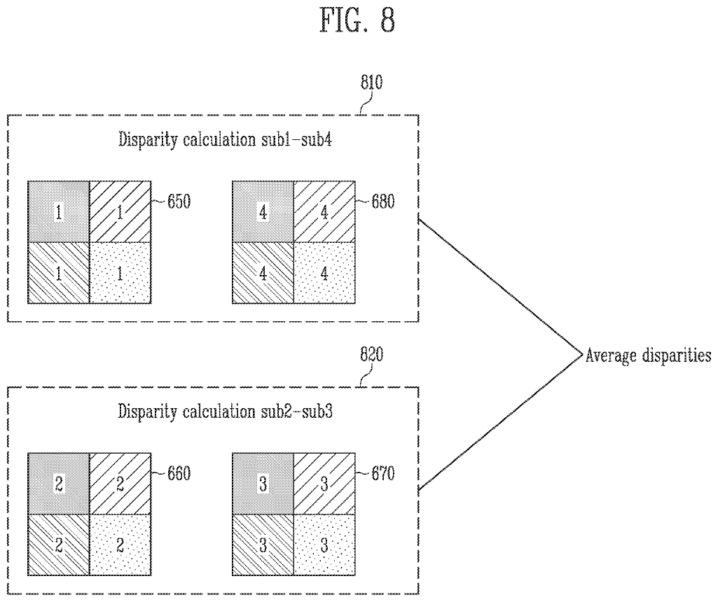

FIG. 8 is a diagram illustrating a method of calculating disparity values according to an embodiment of the present disclosure.

Referring to FIG. 8, a first sub-image 650, a second sub-image 660, a third sub-image 670, and a fourth sub-image 680 may be generated from an original image. The disparity calculator 113 may calculate disparity values only for the out-of-focus area for the sub-images 650, 660, 670, and 680.

In an embodiment of the present disclosure, the disparity calculator 113 may calculate a disparity value between the first sub-image 650 and the fourth sub-image 680 (810), and may calculate a disparity value between the second sub-image 660 and the third sub-image 670 (820). The disparity calculator 113 may determine the average value of the disparity values to be the disparity value between the sub-images 650, 660, 670, and 680. In an embodiment of the present disclosure, the disparity between sub-images composed of sub-pixels located in a diagonal direction in the original image may be calculated, and thus a computational load may be minimized.

In an embodiment of the present disclosure, the disparity calculator 113 may calculate all disparity values between the first sub-image 650, the second sub-image 660, the third sub-image 670, and the fourth sub-image 680. The disparity calculator 113 may determine the average value of the calculated disparity values to be the disparity value between the sub-images. When the disparity values between all sub-images are calculated, the accuracy of disparity values may be improved.

In an embodiment of the present disclosure, the disparity calculator 113 may determine the maximum value or the minimum value of a plurality of disparity values corresponding to the same position to be the disparity value at the corresponding position.

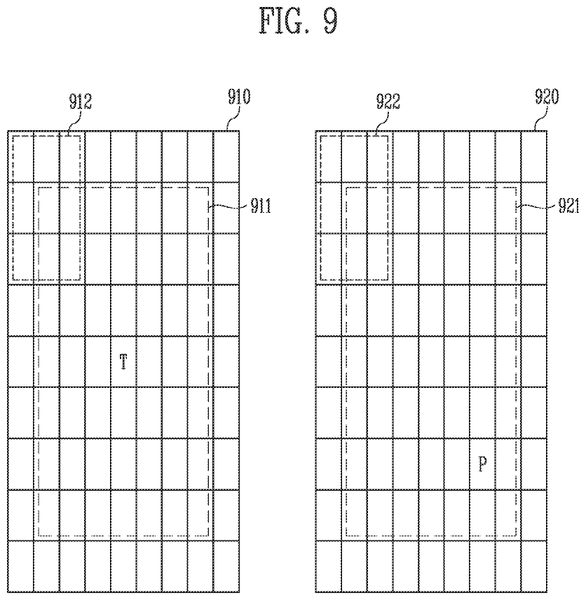

FIG. 9 is a diagram illustrating a method of calculating disparity values using the difference between sub-pixel values according to an embodiment of the present disclosure.

Referring to FIG. 9, a first sub-image 910 and a fourth sub-image 920 are illustrated. A range 911 in which differences between sub-pixel values are calculated may be set based on a position T at which a disparity is to be calculated within the first sub-image 910. Similarly, a disparity calculation range 921 may be set even in the fourth sub-image 920.

In FIG. 9, the size of kernels 912 and 922 for which disparities are compared with each other may be set to 3×3. The disparity calculator 113 may detect a position P at which the difference between sub-pixel values is minimized from the fourth sub-image while moving the kernels 912 and 922 in the ranges 911 and 921 in which disparities are to be calculated.

A distance between the position T at which disparities are to be calculated and the position P at which the difference between the sub-pixel values is minimized may be a disparity value at the position T at which disparities are to be calculated in the sub-image. In the same manner, the disparity calculator 113 may calculate disparity values at the positions of sub-pixels included in the out-of-focus area for the first sub-image 910 and the fourth sub-image 920.

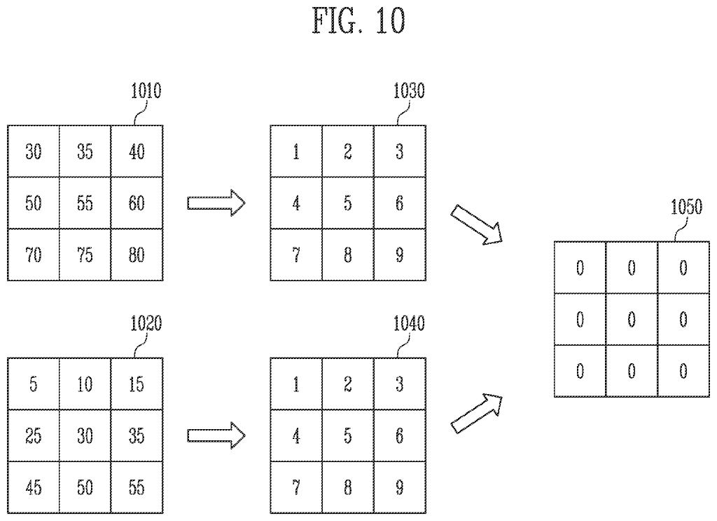

FIG. 10 is a diagram illustrating a method of calculating disparity values using the difference between the rankings of sub-pixel values according to an embodiment of the present disclosure.

Referring to FIG. 10, disparity values of an out-of-focus area may be calculated using the difference between the rankings of the sub-pixel values included in the kernels of sub-images for which disparities are to be calculated.

In FIG. 10, a pixel value 1010 may be assumed to be the sub-pixel value of the kernel 912 of the first sub-image 910 in FIG. 9. A pixel value 1020 may be assumed to be the sub-pixel value of the kernel 922 of the fourth sub-image 920 in FIG. 9. The disparity calculator 113 may determine the ranking 1030 of the pixel value 1010 without calculating the difference between the pixel value 1010 and the pixel value 1020. Similarly, the disparity calculator 113 may determine the ranking 1040 of the sub-pixel value 1020. The disparity calculator 113 may calculate a ranking difference 1050 between kernels by comparing the ranking 1030 of the first sub-image 910 and the ranking 1040 of the fourth sub-image 920 with each other.

In FIG. 10, although the pixel value 1010 is different from the pixel value 1020, the ranking 1030 of the first sub-image 910 may be identical to the ranking 1040 of the fourth sub-image 920. The disparity calculator 113 may determine the disparity values based on the ranking difference 1050 between the kernels. In an embodiment of the present disclosure, the disparity value may be calculated by summing the ranking difference 1050 between the kernels.

In an embodiment of the present disclosure, when the ranking difference between sub-pixel values are used rather than the difference between sub-pixel values is used, the accuracy of calculation of disparity values may be improved even when noise occurs. In an embodiment of the present disclosure, the disparity calculator 113 may detect features included in the sub-images, and may calculate disparity values between the sub-images using the detected features. For example, the disparity values may be calculated using a Dense-SIFT method based on the density of features detected in the sub-images.

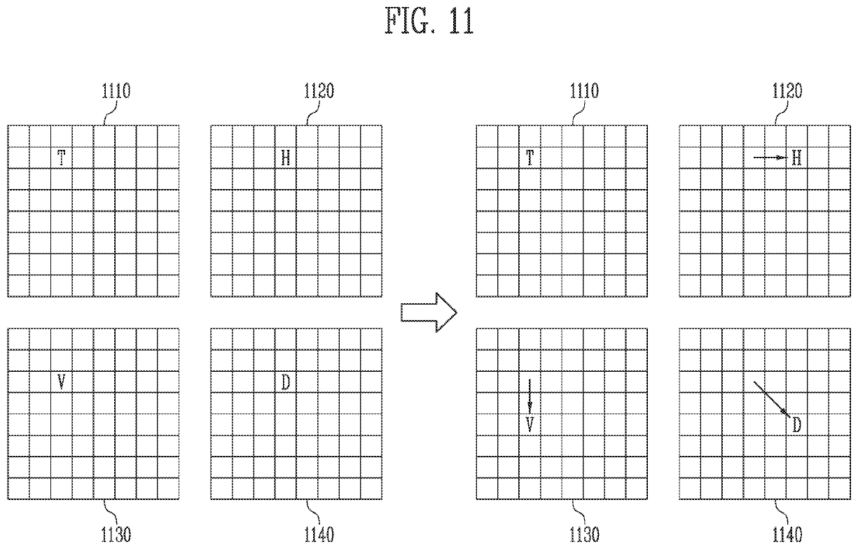

FIG. 11 is a diagram illustrating a method of controlling the strength of a blur operation by scaling disparity values according to an embodiment of the present disclosure.

Referring to FIG. 11, the sub-pixel values of sub-images may be moved depending on a scaling value. In FIG. 11, the strength of a blur operation may be controlled depending on the movement of sub-pixel values of four sub-images 1110, 1120, 1130, and 1140.

The image blurrer 121 may increase the disparity values depending on a preset rate. The image blurrer 121 may set the first sub-image 1110, among the four sub-images 1110, 1120, 1130, and 1140, as a reference image. The sub-pixel values of the reference image 1110 might not be moved, and the image blurrer 121 may determine a direction in which the sub-pixel values of the remaining sub-images 1120, 1130, and 1140 are moved, based on the reference image 1110.

A disparity value at a target position T in the reference image 1110 may be assumed to be 1 pixel. In FIG. 11, a horizontal pixel value H, corresponding to the target position T, in the second sub-image 1120 that is a horizontal sub-image is illustrated. A vertical pixel value V, corresponding to the target position T, in the third sub-image 1130 that is a vertical sub-image is illustrated in FIG. 11. Similarly, a diagonal pixel value D, corresponding to the target position T, in the fourth sub-image 1140 that is a diagonal sub-image is illustrated in FIG. 11.

For example, the image blurrer 121 may scale the disparity value threefold depending on a preset ratio. The sub-pixel values of the sub-images 1120, 1130, and 1140 other than the reference image 1110 may be moved in the direction corresponding to the reference image 1110. In accordance with scaling of the disparity value, the horizontal pixel value H, corresponding to the target position T, in the second sub-image 1120 may be moved by three pixels in the horizontal direction. Similarly, the vertical pixel value V, corresponding to the target position T, in the third sub-image 1130 may be moved by three pixels in the vertical direction. The diagonal pixel value D, corresponding to the target position T, in the fourth sub-image 1140 may be moved by three pixels in the diagonal direction.

The image blurrer 121 may generate a blurred image including the average values of the sub-pixel values of the sub-images 1120, 1130, and 1140, the pixel values of which have moved depending on the disparity value, and the reference image 1110. In an embodiment of the present disclosure, the image blurrer 121 may generate a blurred image including the median values of the sub-pixel values of the sub-images 1120, 1130, and 1140, the pixel values of which have moved, and the reference image 1110.

The image blurrer 121 may perform a blur operation only on a background by summing only the sub-pixel values corresponding to an out-of-focus area. In an embodiment of the present disclosure, the rate at which the disparity values are scaled may be determined based on information received from a user.

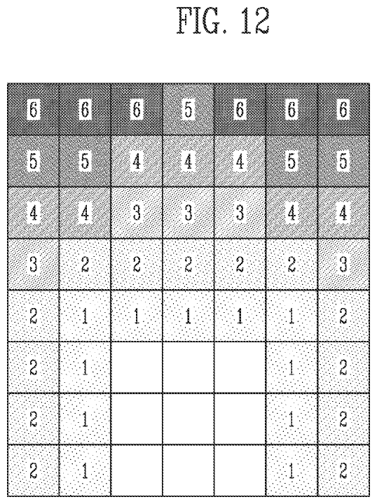

FIG. 12 is a diagram illustrating a method of controlling the strength of a blur operation by changing the sharpness of a Gaussian filter according to an embodiment of the present disclosure.

Referring to FIG. 12, the image blurrer 121 may generate an intermediate image by summing the pixel values of sub-images. In FIG. 12, the intermediate image may be represented. In FIG. 12, a shaded portion may indicate an out-of-focus area. In FIG. 12, numerals in the shaded portion may indicate disparity values in the out-of-focus area.

The image blurrer 121 may generate a blurred image by applying a Gaussian filter only to the shaded portion of the intermediate image. In an embodiment of the present disclosure, when the intermediate image is generated, noise occurring in a sub-image may be removed. The image blurrer 121 may generate the blurred image by changing the sharpness of the Gaussian filter depending on the disparity values.

In an embodiment of the present disclosure, a Gaussian filter might not be applied to the in-focus area for the intermediate image. The image blurrer 121 may perform the blur operation using a Gaussian filter having a preset size to the out-of-focus area for the intermediate image.

In an embodiment of the present disclosure, as the disparity values of the intermediate image are greater, the sharpness of the curve of the Gaussian filter to be applied to the corresponding position may be decreased. When a Gaussian filter having a low curve sharpness is applied to the intermediate image, the strength of the blur operation may be increased.

In an embodiment of the present disclosure, the sharpness of the curve of the Gaussian filter applied to pixels having a disparity value of 1 in the out-of-focus area may be higher than the sharpness of the curve of the Gaussian filter applied to pixels having a disparity value of 2. That is, as the disparity value is larger, the strength of the blur operation that is performed may be increased. In FIG. 12, the case where disparity values ranging from 1 to 6 are calculated is illustrated.

In an embodiment of the present disclosure, the kernel size of the Gaussian filter may vary depending on the disparity value of the intermediate image. For example, as the disparity value is larger, the kernel size of the Gaussian filter that is applied to the corresponding position may be increased. As the kernel size of the Gaussian filter is larger, the strength of the blur operation may be increased.

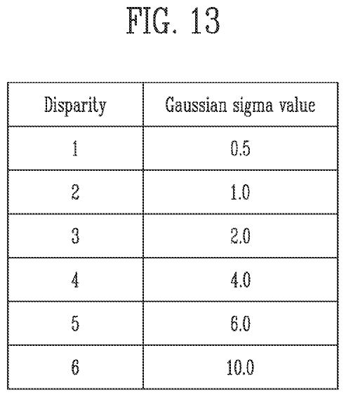

FIG. 13 illustrates a table in which disparity values are mapped to sharpness values of a Gaussian filter according to an embodiment of the present disclosure.

Referring to FIG. 13, Gaussian sigma values indicating the sharpness of the Gaussian filter are mapped to disparity values. In FIG. 13, as the disparity value is larger, the Gaussian sigma value may be increased. In an embodiment of the present disclosure, as the Gaussian sigma value is larger, the sharpness of the curve of the Gaussian filter may be lower.

In an embodiment of the present disclosure, the degree of an increase in the Gaussian sigma value might not be proportional to the degree of an increase in the disparity value. Matching between the disparity values and the Gaussian sigma values shown in FIG. 13 is only an example, and there may be various matching relationships therebetween.

When the table of FIG. 13 is applied to FIG. 12, the Gaussian filter may be applied to the out-of-focus area for the intermediate image. The image blurrer 121 may apply Gaussian filters having different curve sharpness values to pixel values included in the out-of-focus area depending on the disparity values of the intermediate image. For example, the sigma value of the Gaussian filter applied to sub-pixels in an out-of-focus area having a disparity value of 3 may be different from the sigma value of the Gaussian filter applied to sub-pixel values in an out-of-focus area having a disparity value of 4.

In an embodiment of the present disclosure, a Gaussian sigma value mapped to each disparity value may be changed depending on the information received from the user. For example, a Gaussian sigma value corresponding to a disparity value of 5 in FIG. 13 may be changed from 6.0 to 8.0 depending on user information. When the Gaussian sigma value is changed, the sharpness of the curve of the Gaussian filter applied to the corresponding position may also be changed.

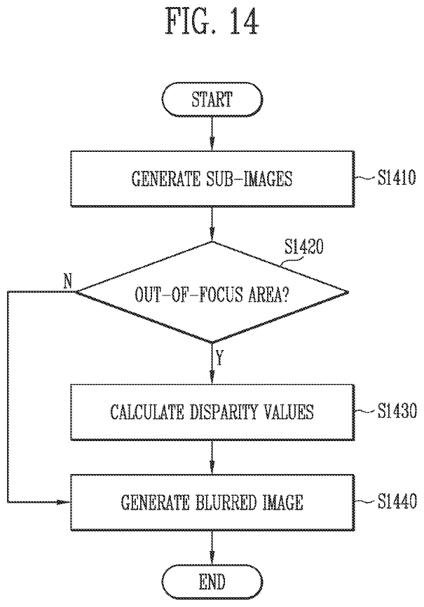

FIG. 14 is a flowchart illustrating a method of performing a blur operation on a background according to an embodiment of the present disclosure.

Referring to FIG. 14, the image processing device may control the strength of a blur operation performed on an out-of-focus area for an image.

At step S1410, an image separator may generate sub-images of an image based on externally received sub-pixel values. The image separator may sample at least one sub-pixel value for each of pixel groups respectively corresponding to micro-lenses. The image separator may generate a plurality of sub-images based on the sampled sub-pixel values. In an embodiment of the present disclosure, the number of sub-images generated by the image separator may be identical to the number of sub-pixel values corresponding to the same micro-lens. The description of FIG. 6 may correspond to step S1410.

In an embodiment of the present disclosure, information about the colors of sub-pixels may be changed to information about one preset color before step S1420. For example, when information about a red color and information about a blue color are changed to information about a green color, a computational load may be optimized in subsequent operations. In an embodiment of the present disclosure, information about the color of each pixel value may be changed to information about brightness.

At step S1420, the area detector may determine an in-focus area and an out-of-focus area for the generated sub-images. The area detector may compare the difference between the maximum value and the minimum value of sub-pixel values at the same position (i.e., co-located sub-pixel values) in the sub-images with a preset threshold value.

The area detector may determine the position of sub-pixels, for which the difference between the maximum value and the minimum value is less than the threshold value, to be in an in-focus area. An additional computation (operation) or image signal processing operation might not be performed on sub-pixel values corresponding to the in-focus area. The area detector 112 may determine the position of sub-pixels, for which the difference between the maximum value and the minimum value is equal to or greater than the threshold value, to be in an out-of-focus area. A blur operation may be performed on sub-pixel values corresponding to the out-of-focus area. The description of FIG. 7 may correspond to step S1420.

At step S1430, the disparity calculator may calculate disparity values for the out-of-focus area for the sub-images. The disparity calculator may calculate disparity values between the sub-images using the pixel value differences between the sub-pixel values corresponding to the out-of-focus area. In an embodiment of the present disclosure, the disparity calculator may calculate the disparity values between sub-images using the difference between the rankings of the sub-pixel values. In an embodiment of the present disclosure, the disparity calculator may calculate disparity values between the sub-images based on the density of features detected in the sub-images. The descriptions of FIGS. 8, 9, and 10 may correspond to step S1430.

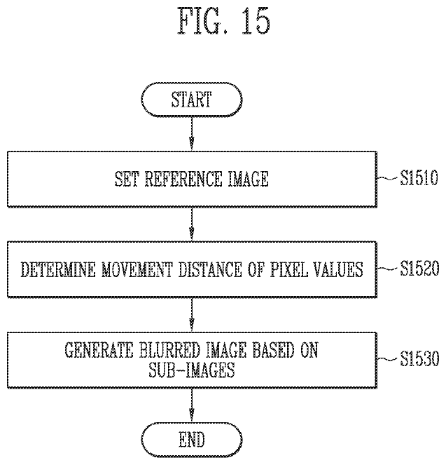

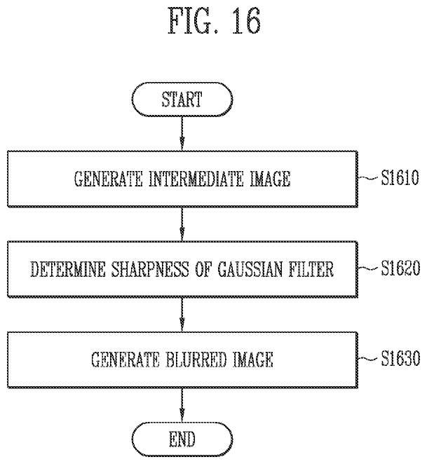

At step S1440, an image combiner may generate a blurred image by performing a blur operation based on the disparity values in the out-of-focus area. A method in which the image combiner controls the strength of the blur operation based on the disparity values and sums sub-images on which the blur operation is performed will be described later with reference to FIG. 15. A method in which the image combiner generates a blurred image by applying a Gaussian filter to an intermediate image based on the disparity values will be described later with reference to FIG. 16.

In an embodiment of the present disclosure, in response to the change of the information about colors before step S1420, information about the changed colors may be reconstructed into the information about colors before change, after step S1440.

In an embodiment of the present disclosure, the resolution of the image sensed by an image sensor is decreased, but a blurred image in which the blur operation is performed on the background included in the image may be generated. The changed resolution may differ depending on the number of color pixels corresponding to the same micro-lens. For example, when the number of sub-pixels corresponding to one micro-lens is 4, the resolution of the blurred image may be decreased to ¼ of that of the original image. In an embodiment of the present disclosure, unlike the decrease in resolution, the accuracy of the blur operation performed may be improved depending on the number of color pixels corresponding to the same micro-lens.

FIG. 15 is a flowchart illustrating a method of generating a blurred image according to an embodiment of the present disclosure.

Referring to FIG. 15, the image blurrer may increase disparity values depending on a preset rate. The image blurrer may move sub-pixel values corresponding to an out-of-focus area in the sub-images based on the disparity values.

At step S1510, the image blurrer may set one of sub-images as a reference image. The reference image may be randomly selected from among the sub-images.

At step S1520, the image blurrer may determine the movement distance of the sub-pixel values. The movement distance of the sub-pixel values may vary with the movement direction of the sub-pixel values. When the sub-pixel values are moved, the disparity values between the sub-images may be increased. When the disparity values are increased, the blurred image may be displayed to be blurrier than the original image.

At step 1530, the image blurrer may generate the blurred image by summing the sub-images, the disparity values of which are scaled. The image blurrer may generate a blurred image including the average values of sub-pixel values at the same position (co-located pixel values). The blurred image may have a resolution lower than that of the original image. The description of FIG. 11 may correspond to FIG. 15.

FIG. 16 is a flowchart illustrating a method of generating a blurred image according to an embodiment of the present disclosure.

Referring to FIG. 16, the image blurrer may determine the sharpness of a Gaussian filter that is applied to the out-of-focus area for the intermediate image based on disparity values.

At step S1610, the image blurrer may generate an intermediate image including the average values of sub-pixel values at the same position (co-located sub-pixel values) in the sub-images. The position detected as being in the out-of-focus area in the sub-images may be identical to the position of the out-of-focus area in the intermediate image.

At step S1620, the image blurrer may determine the sharpness of the Gaussian filter to be applied to the intermediate image depending on the disparity values. In an embodiment of the present disclosure, a Gaussian filter might not be applied to the in-focus area for the intermediate image. The image blurrer may perform the blur operation using a Gaussian filter having a preset size to the out-of-focus area for the intermediate image.

In an embodiment of the present disclosure, as the disparity values of the intermediate image are greater, the sharpness of the curve of the Gaussian filter to be applied to the corresponding position may be decreased. When a Gaussian filter having the low curve sharpness is applied to the intermediate image, the strength of the blur operation may be increased.

At step S1630, the image blurrer may generate a blurred image to which the Gaussian filter is applied to the out-of-focus area. The sharpness of the Gaussian filter that is applied to sub-pixel values may vary. The image blurrer may apply a Gaussian filter having low curve sharpness to the sub-pixel values as the disparity value of the intermediate image is larger. The descriptions of FIGS. 12 and 13 may correspond to FIG. 16.

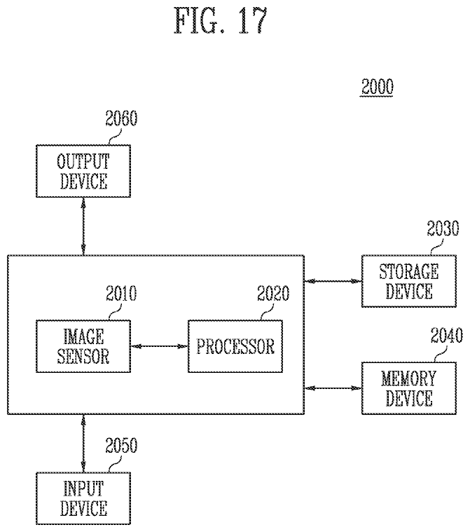

FIG. 17 is a block diagram illustrating an electronic device including an image processing device according to an embodiment of the present disclosure.

Referring to FIG. 17, an electronic device 2000 may include an image sensor 2010, a processor 2020, a storage device 2030, a memory device 2040, an input device 2050, and an output device 2060. Although not illustrated in FIG. 17, the electronic device 2000 may further include ports capable of communicating with a video card, a sound card, a memory card, or a universal serial bus (USB) device, or communicate with other electronic devices.

The image sensor 2010 may generate image data corresponding to incident light. The image data may be transferred to and processed by the processor 2020. The output device 2060 may display the image data. The storage device 2030 may store the image data. The processor 2020 may control the operations of the image sensor 2010, the output device 2060, and the storage device 2030.

The processor 2020 may be an image processing device which performs an operation of processing the image data received from the image sensor 2010 and outputs the processed image data. Here, processing may include electronic image stabilization (EIS), interpolation, tonal (hue) correction, image quality correction, size adjustment, etc.

The processor 2020 may be implemented as a chip independent of the image sensor 2010. For example, the processor 2020 may be implemented as a multi-chip package. In an embodiment of the present disclosure, the processor 2020 and the image sensor 2010 may be integrated into a single chip so that the processor 2020 is included as a part of the image sensor 2010.

The processor 2020 may execute and control the operation of the electronic device 2000. In accordance with an embodiment of the present disclosure, the processor 2020 may be a microprocessor, a central processing unit (CPU), or an application processor (AP). The processor 2020 may be coupled to the storage device 2030, the memory device 2040, the input device 2050, and the output device 2060 through an address bus, a control bus, and a data bus, and may then communicate with the devices.

In an embodiment of the present disclosure, the processor 2020 may perform a preprocessing operation of separating an original image into sub-images based on the received image data, detecting an in-focus area and an out-of-focus area from the sub-images, and calculating disparity values between the sub-images. The processor 2020 may perform a blur operation on the out-of-focus area depending on the disparity values, and may generate a blurred image by summing the sub-images. In this case, the strength of the blur operation that is performed may vary depending on the disparity values. In accordance with an embodiment of the present disclosure, the blur operation is performed only on the out-of-focus area for the sub-images, and thus the complexity of computation may be decreased.

The storage device 2030 may include all types of nonvolatile memory devices including a flash memory device, a solid-state drive (SSD), a hard disk drive (HDD), and a CD-ROM.

The memory device 2040 may store data required for the operation of the electronic device 2000. For example, the memory device 2040 may include volatile memory such as a dynamic random-access memory (DRAM) or a static random-access memory (SRAM), or may include nonvolatile memory such as erasable programmable read-only memory (EPROM), electrically erasable programmable read-only memory (EEPROM), or flash memory. The processor 2020 may control the image sensor 2010 and the output device 2060 by executing an instruction set stored in the memory device 2040.

The input device 2050 may include an input means such as a keyboard, a keypad, or a mouse, and the output device 2060 may include an output means such as a printer device or a display.

The image sensor 2010 may be implemented as various types of packages. For example, at least some components of the image sensor 2010 may be implemented using any of packages such as package on package (PoP), ball grid arrays (BGAs), chip scale packages (CSPs), plastic leaded chip carrier (PLCC), plastic dual in line package (PDIP), die in waffle pack, die in wafer form, chip on board (COB), ceramic dual in line package (CERDIP), plastic metric quad flat pack (MQFP), thin quad flat pack (TQFP), small outline integrated circuit (SOIC), shrink small outline package (SSOP), thin small outline package (TSOP), system in package (SIP), multi-chip package (MCP), wafer-level fabricated package (WFP), and wafer-level processed stack package (WSP).

Meanwhile, the electronic device 2000 may be construed as any computing system using the image sensor 2010. The electronic device 2000 may be implemented in the form of a packaged module, a part, or the like. For example, the electronic device 2000 may be implemented as a digital camera, a mobile device, a smartphone, a personal computer (PC), a tablet PC, a notebook computer, a personal digital assistant (PDA), an enterprise digital assistant (EDA), a portable multimedia player (PMP), a wearable device, a black box, a robot, an autonomous vehicle, or the like.

According to the present disclosure, there may be provided an image processing system, which may blur a background included in an image using one camera and control the strength of a blur operation.

It should be noted that the scope of the present disclosure is defined by the accompanying claims, rather than by the foregoing detailed descriptions, and all changes or modifications derived from the meaning and scope of the claims and equivalents thereof are included in the scope of the present disclosure.

What is claimed is:

1. An image processing device, comprising:
an image preprocessor configured to determine an in-focus area and an out-of-focus area for sub-images of an externally received image, the sub-images generated based on pixel values of the externally received image, and to calculate disparity values between the sub-images in the out-of-focus area; and
an image combiner configured to generate a blurred image in which a blur operation is performed on the out-of-focus area,
wherein a strength of the blur operation is determined based on the disparity values.

2. The image processing device according to claim 1, wherein the image preprocessor comprises:
an image separator configured to sample sub-pixel values respectively corresponding to a plurality of micro-lenses included in an image sensor and to generate the sub-images based on the sampled sub-pixel values,
wherein a number of sub-images is equal to a number of sub-pixel values corresponding to an identical micro-lens.

3. The image processing device according to claim 1, wherein the image preprocessor comprises:
an area detector configured to compare a difference between a maximum value and a minimum value of co-located sub-pixel values in the sub-images with a preset threshold value, and determine a position of sub-pixels at which the difference is less than the preset threshold value, to be in the in-focus area.

4. The image processing device according to claim 1, wherein the image preprocessor comprises:
a disparity calculator configured to calculate the disparity values using a difference between sub-pixel values corresponding to the out-of-focus area, a difference between rankings of the sub-pixel values, or features detected from the sub-images.

5. The image processing device according to claim 1, wherein the image combiner comprises:
an image blurrer configured to increase the disparity values depending on a preset rate, wherein the strength of the blur operation is changed in response to the increase in the disparity values.

6. The image processing device according to claim 5, wherein the image blurrer is configured to set a reference image among the sub-images, and move sub-pixel values of remaining sub-images other than the reference image in a direction corresponding to the reference image.

7. The image processing device according to claim 6, wherein the image blurrer is configured to determine a movement distance of the sub-pixel values of the remaining sub-images based on the present rate and the disparity values, and generate the remaining sub-images, the sub-pixel values of which are moved.

8. The image processing device according to claim 7, wherein the image combiner is configured to calculate average values of the sub-pixel values of the reference image and the remaining sub-images, which are co-located sub-pixel values in the out-of-focus area, and generate a blurred image based on the average values.

9. The image processing device according to claim 1, wherein the image combiner comprises:
an image blurrer configured to generate an intermediate image in which the sub-images are summed in the out-of-focus area and to apply a filter to the intermediate image based on the disparity values.

10. The image processing device according to claim 9, wherein the image blurrer is configured to apply a Gaussian filter to the intermediate image, and change the sharpness of the Gaussian filter depending on the disparity values.

11. The image processing device according to claim 10, wherein the image blurrer is configured to select a curve of a Gaussian filter having lower curve sharpness as the disparity values are larger.

12. The image processing device according to claim 9, wherein the image blurrer is configured to control the strength of the filter to be applied to the intermediate image depending on a preset rate.

13. An image processing method, comprising:
generating sub-images based on externally received image data;
determining an in-focus area and an out-of-focus area for the sub-images;
calculating disparity values in the out-of-focus area; and
generating a blurred image on which a blur operation is performed based on the disparity values in the out-of-focus area.

14. The image processing method according to claim 13, wherein generating the sub-images comprises:
receiving image data from an image sensor including a plurality of micro-lenses; and
generating the sub-images by sampling the image data,
wherein a number of sub-images is equal to a number of sub-pixels respectively corresponding to the plurality of micro-lenses.

15. The image processing method according to claim 13, wherein determining the out-of-focus area comprises:
comparing a difference between a maximum value and a minimum value of co-located sub-pixel values in the sub-images with a preset threshold value; and
determining a position of the sub-pixels, for which the difference is equal to or greater than the threshold value, to be in the out-of-focus area.

16. The image processing method according to claim 13, wherein calculating the disparity values comprises:
calculating the disparity values based on at least one of a difference between sub-pixel values corresponding to the out-of-focus area, a difference between rankings of the sub-pixel values, or features detected from the sub-images.

17. The image processing method according to claim 13, wherein generating the blurred image comprises:
determining a strength of the blur operation based on a preset rate and the disparity values.

18. The image processing method according to claim 17, wherein generating the blurred image comprises:
setting a reference image among the sub-images;
moving sub-pixel values of remaining sub-images other than the reference image in a preset direction based on the strength of the blur operation; and
generating the blurred image based on the reference image and the remaining sub-images, the sub-pixel values of which are moved.

19. The image processing method according to claim 13, wherein generating the blurred image comprises:
generating an intermediate image in which the sub-images are summed;
determining the sharpness of a Gaussian filter to be applied to the out-of-focus area depending on the disparity values; and
applying the Gaussian filter to the intermediate image.

20. An image processing system, comprising:
an image sensor including a plurality of micro-lenses and a plurality of sub-pixels configured such that respective N sub-pixels correspond to each of the micro-lenses, the image sensor being configured to generate image data including information about brightness and a phase in the plurality of sub-pixels;
an image preprocessor configured to generate N sub-images based on the image data, determine an out-of-focus area for N sub-images, and calculate disparity values of sub-pixels included in the out-of-focus area; and
an image combiner configured to perform a blur operation on the out-of-focus area depending on a strength of the blur operation determined based on the disparity values.
